(19) United States
(12) Patent Application Publication
(10) Pub. No.: US 2023/0289462 A1
(43) Pub. Date: Sep. 14, 2023

(54) SYSTEM AND METHOD FOR CALENDAR WITH SECURED DATA EXCHANGE AND COORDINATED SCHEDULING

(71) Applicant: Ligero, Inc., Pittsford, NY (US)

(72) Inventors: Muthuramakrishnan Venkita Subramaniam, Chappaqua, NY (US); Carmit Hazay, Modi'in (IL); Thuan Gia Pham, Rochester, NY (US); Ruihan Wang, Hyattsville, MD (US); Vu Hoang Nguyen, Da Nang City (VN); Yuriy Kashnikov, Novosibirsk (RU)

(21) Appl. No.: 18/120,070

(22) Filed: Mar. 10, 2023

Related U.S. Application Data
(60) Provisional application No. 63/318,576, filed on Mar. 10, 2022.

(51) Int. Cl. G06F 21/62; G06Q 10/1093

(52) U.S. Cl. CPC G06F 21/6218; G06Q 10/1095

(57) ABSTRACT

Systems and methods for scheduling and calendaring are provided in various embodiments. Systems, methods and software for accessing two or more electronic or online calendars for scheduling systems to allow for efficient identification and collection of available times and dates, without accessing or using any private or other information from the calendars. Systems, methods and software to also collect available times across multiple calendars, identify available overlapping open times and produce a set of available times and dates for an event across the various calendars, with then the option to schedule the event during one of the available times. Secure multiparty computation is applied to maintain privacy and security while allowing for the access, identification and collection of open times across each of various calendars or scheduling systems.

### FIELD OF THE DISCLOSURE

This application claims the benefit of the filing date of U.S. Provisional Patent Application Ser. No. 63/318,576, filed Mar. 10, 2022, which is hereby incorporated by reference in its entirety.

The present disclosure relates to electronic or online calendars and scheduling systems, and more specifically to systems and methods for securely sharing events and setting common appointments with private data protection in online calendar and scheduling systems.

### BACKGROUND

Examples of conventional electronic or online calendars and scheduling systems include the calendars in Outlook and Gmail, among many others. Scheduling meetings and events across different calendar systems and/or across the calendars of two or more individuals or entities is a common and growing problem. Existing calendar applications and tools have been developed to take polls of availability or to share one calendar at a time with another invitee. However, calendars often include private or personal information that most individuals or entities do not want or cannot allow to be available to others. Examples of such private or personal information include personal identifiable information, personal events mixed in with professional or business events, competitive information, confidential or privileged or secret information, government information for government entities or individuals, medical information in terms of doctor's appointments or tests, and so forth. As such, the vast majority of individuals and entities do not share their calendar broadly nor open it to other entities or individuals. This causes many issues including an inefficient and time consuming process to call or e-mail other invitees to collect availability manually, and then repeatedly contact invitees to try to find a common open time for the meeting or event.

Conventional systems, methods, tools or software approaches for calendars or schedulers do not allow individuals or entities to open their calendar to another entity while maintaining control of their private information, including their other meetings or events and up to and including their name and e-mail address and personal identification information. Even systems that allow a person or entity to mark events as “private” or “hidden” do not allow for such extensive privacy. Further, marking all events as private or hidden in existing approaches is inefficient and may be difficult in terms of being able to share different levels of openness for different purposes or entities.

### SUMMARY

Unlike conventional calendar systems or scheduling tools, some embodiments herein allow a meeting scheduler to do some or all of defining the parameters of a meeting, requesting access to the calendars of all invitees, automatically accessing all calendars to find available times without revealing any personal, or private information, while still being able to identify openings to then schedule the meeting. Further, embodiments herein include a prioritization rubric to set time, time zone, attendee prioritization, etc., to automatically find times for the most important attendees or even flag times on the scheduler's calendar that could be moved for priorities.

In some embodiments, a computer implemented method comprising: accessing, by one or more processors, two or more electronic calendars for scheduling systems operatively coupled one another via a digital communication network; collecting, by the one or more processors, available times and dates across multiple calendars via a preconfigured secure communication without revealing any private data from the calendars based on secure multiparty computation mechanism; identifying, by the one or more processors, available overlapping open times; and producing, by the one or more processors, a set of available times and dates for an event across the various calendars, with then the option to schedule the event during one of the available times.

In some embodiments, a computer implemented method comprising: accessing, by a secure calendar management device, two or more electronic calendars; collecting, by the secure calendar management device, available times and dates from the two or more accessed electronic calendars via a preconfigured secure communication without accessing private data from the two or more electronic calendars using a secure multiparty computation mechanism; identifying, by the secure calendar management device overlapping available times and dates on the two or more electronic calendars based on the collected available times and dates from the two or more electronic calendars; and providing, by the secure calendar management device, a set of available times and dates for an event based on the identified overlapping available times and dates and an option to schedule the event during one of the available times and dates in the set of available times and dates; wherein the secure calendar management device comprises one or more processors.

Additional features may include: selecting, by the secure calendar management device, one of the available times and dates in the set of available times and dates; and automatically creating, by the secure calendar management device, a calendar invite using the selected one of the available times and dates. A first available time and date may be selected from the set of available times and dates for the calendar invite. Some further options may include: prioritizing, by the secure calendar management device, one or more days or one or more times; selecting, by the secure calendar management device, the one of the available times and dates in the set of available times and dates based on the prioritized one or more days or one or more times.

Additionally, in some embodiments, the two or more electronic calendars are associated with two or more invitees to a meeting, and in some cases the two or more electronic calendars are associated with invitees in two or more different organizations or in two or more different scheduling systems. Optionally, the secure calendar management device may prioritize at least one of the invitees, and select one of the available times and dates in the set of available times and dates based on the prioritized at least one or the invitees.

In some embodiments, the computer implemented method may include an identifying step which is performed using a secure multiparty computation protocol. The secure multiparty computation protocol may be run on one or more nodes, and in some embodiments a user may operate one of the nodes. The secure multiparty computation protocol may include security against an active adversary. The secure multiparty computation protocol may be concretely efficient. The secure multiparty computation may comprise at least one of an active secure MPC protocol, authenticated garbling protocol, SPDZ-type protocol, LevioSA MPC protocol, SCALE-MAMBA protocol, or Diogenes MPC protocol.

In some embodiments, only an electronic mail address for each invitee is used in the system for creating a calendar invite using one of the available times and dates.

The preconfigured secure communication may include one or more of communication using internet, web, cloud or blockchain protocols.

In some embodiments, the two or more electronic calendars are associated with two or more invitees to a meeting, the method further comprising: receiving, by the secure calendar management device, an optional manual input in the collecting step for one of the invitees to choose open times on its calendar for its available times and dates. In some embodiments, the invitee chooses open times from those that have been identified to be available times and dates from the other invitee's calendars. Further embodiments may comprise one or more invitees identified as optional, and further comprising excluding that optional invitee's available times from the identifying step if such optional invitee is not available during at least one time that overlaps with the available overlapping times of the other invitees.

In some embodiments, a non-transitory computer readable medium having stored thereon instructions for calendar management and scheduling comprising machine executable code which when executed by at least one processor, causes the processor to: access by a secure calendar management device, two or more electronic calendars; collect, by the secure calendar management device, available times and dates from the two or more accessed electronic calendars via a preconfigured secure communication without accessing private data from the two or more electronic calendars using a secure multiparty computation mechanism; identify, by the secure calendar management device overlapping available times and dates on the two or more electronic calendars based on the collected available times and dates from the two or more electronic calendars; and provide, by the secure calendar management device, a set of available times and dates for an event based on the identified overlapping available times and dates and an option to schedule the event during one of the available times and dates in the set of available times and dates; wherein the secure calendar management device comprises one or more processors. Further embodiments and optional features described in relation to the computer implemented method embodiments and steps above may be instructions and steps used by the non-transitory computer medium.

In some embodiments, a secure calendar management computing device, comprising a memory comprising program instructions stored thereon and one or more processors configured to execute the stored program instructions to: access by a secure calendar management device, two or more electronic calendars; collect, by the secure calendar management device, available times and dates from the two or more accessed electronic calendars via a preconfigured secure communication without accessing private data from the two or more electronic calendars using a secure multiparty computation mechanism; identify, by the secure calendar management device overlapping available times and dates on the two or more electronic calendars based on the collected available times and dates from the two or more electronic calendars; and provide, by the secure calendar management device, a set of available times and dates for an event based on the identified overlapping available times and dates and an option to schedule the event during one of the available times and dates in the set of available times and dates; wherein the secure calendar management device comprises one or more processors. Further embodiments and optional features described in relation to the computer implemented method embodiments and steps above may be instructions and steps used by the secure calendar management computing device and executed by the one or more processors.

### BRIEF DESCRIPTION OF THE DRAWINGS

FIG. 1 depicts components and workflow of a calendar management system with secured data exchange and coordinated scheduling referred to as secure calendar management system;

FIG. 1B depicts the system components and secure data exchange connections of a secure calendar management system;

FIG. 2 depicts an embodiment of a window to create and schedule a meeting describing parameters and respective values;

FIG. 3 depicts an example of a standalone user interface for displaying available slots and prompting for selection;

FIG. 4 depicts an example of an email listing available time slots for notification to the scheduler;

FIG. 5 depicts an embodiment of a registration process utilizing the calendar management system with a smart contract; and

FIG. 6 depicts an embodiment of an event scheduling process utilizing the calendar management system with a smart contract and blockchain.

### DETAILED DESCRIPTION

The system of the present disclosure allows a group of users to identify a meeting time compatible with their individual calendars while guaranteeing privacy protections of their individual data using secure multiparty computation (MPC).

Secure multiparty computation is a distributed protocol running between many computer nodes and facilitates the computation of any function over data jointly held by all the computers in such a way that the computer nodes exchange messages with each other and reveal only the output of the function and nothing else. Communication may be via internet, web, cloud or blockchain protocols, and any combinations of any or all of these.

Either via a stand-alone application, a web-based application, or an extension (plugin) to an existing calendar service (for example, Microsoft outlook, Google calendar, Apple calendar) the embodiments of the present disclosure will facilitate identifying a meeting time. Secure multiparty computation (MPC) will be used for identifying the common time or times where all users supply their available times for the meeting window and the protocol will find all times where the users, or a prioritized subset of users, are all simultaneously available to meet. Secure multiparty computation embodiments used herein offer the guarantee that if the computation is run among n computer nodes then only the output of the computation is revealed even if up to t nodes collude for some threshold t<n, and in some cases t=n−1.

The system of the present disclosure will help identify/compute a meeting time between a group of users where all the users are free, i.e. they have no other event scheduled at that time in their calendar. In some embodiments, the time may not be completely free but may be marked as a space that could be free for certain priorities, under certain conditions or for certain schedulers. Such preferences may be based on flags or indicators set in the calendar system being used, for example based on the priority settings available to be set in a Google, Outlook or other calendar system. The user initiating the meeting is referred to as the “Scheduler” and the users invited to the meeting are referred to as “Invitees”. The Scheduler may prioritize the Invitees to ensure certain Invitees are available, with others being optional.

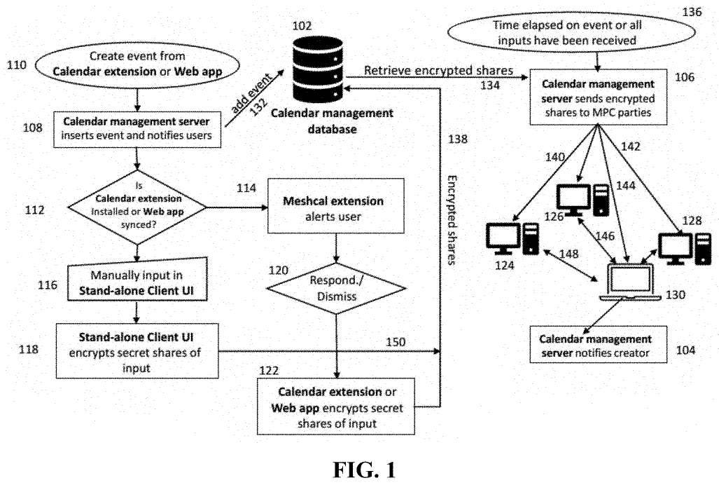

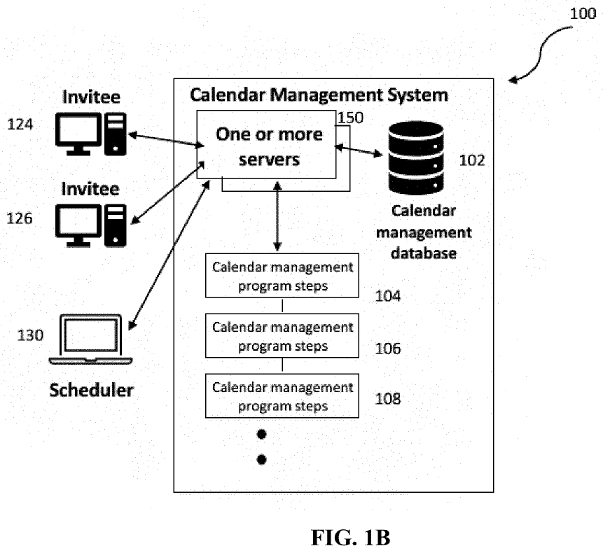

Embodiments of a secure calendar management system system 100 of FIG. 1 and FIG. 1B include: a calendar extension or web application 110, a calendar management server 150, a calendar management database 102, and standalone client user interface (UI) 118. MeshCal or the MeshCal system or MeshCal components throughout the description herein are used as shorthand for and interchangeable with a secure calendar management system or calendar management components described herein. The MeshCal system or calendar management system include various embodiments and elements, including computer implemented methods, non-transitory computer readable media and calendar management computing devices, operating various steps for calendar management and scheduling.

The calendar extension or calendar management extension indicates either a stand-alone application, a web application which may not require any installing, or an extension to a service (examples include Outlook add-ins, Google Workspace App, Browser add-in). On the Scheduler 130 side, this component allows for creating an event. On the Invitee 124 side, this component allows responding to requests. The calendar extension authenticates with an underlying calendar service to access privileged calendar data. It interacts with the calendar management server to initiate event requests, respond to requests and supply calendar information. The extension contains the following subcomponents: Client UI for Schedulers, External Calendar Host Services, and Client Encryption Manager. These subcomponents are described below.

The one or more calendar management servers 150 receive requests from a calendar extension component and can interact with calendar extension or web application in an Invitee device 124. The calendar management server is connected to the calendar management database and a notification or calendar service. The calendar management Server 150 stores and retrieves information from the calendar management database 102.

The calendar management database 102 records and holds data on events and the encrypted input shares and encrypted secret shares from the users. The calendar management database may be accessed by the calendar management server.

In some embodiments, the Standalone Client User Interface 116 allows users to provide inputs manually if the calendar extension is not installed or they haven't previously signed up as a user or used the web-based system. The Standalone Client User Interface interacts with the one or more MeshCal servers 150. If a user does not have the extension installed in their computer system or calendar service, a link is provided by e-mail—the link is a website address leading to a webpage that hosts the standalone Client User Interface where the user can manually enter its available in the date and timeslots identified by the Scheduler in the meeting invite or event information. In many cases, the users get an email and they click a link. When the link is opened, and if they are current users, the browser may have stored cookies and they may automatically have their calendar availability loaded so they can review and send. If they are not current users, they can manually enter their availability, and/or they may sync their calendars to automatically load availability. Synching calendars may include signing into the user's individual Microsoft outlook or Google accounts, or other similar calendar host service accounts, in which their calendar resides. When a user syncs once with the system, they may automatically become a MeshCal user from that point forward.

The calendar management server of FIG. 1 and FIG. 1B includes client UI for schedulers 130, external calendar host services, and a client encryption manager.

The Client UI for Schedulers 130 includes a user interface to allow schedulers to request meetings seamlessly, securely and easily. The Client UI for Schedulers may utilize Web components and Javascript to generate the Client UI for the Scheduler, and algorithms for secret sharing and encryption which ensure the users' calendar information are kept private and are being protected.

The external calendar host services indicates calendar host services such as Outlook, Google, etc. By use of the external calendar host services, the calendar management system 100 connects to third party calendar services such as Microsoft Outlook using Microsoft Graph application programming interface (API) or other Representational state transfer (REST) based services, referred to as RESTful services, and the like, to gather the available or busy time(s) for a user automatically without the user's input or action.

The client encryption manager includes calendar management system encryption components to ensure data are secured and protected before being transmitted. Calendar management system encryption contains an encryption component to encrypt the secret shares of the available and/or busy times for the users from their calendars and transmits those secret shares to the calendar management server which records them in the calendar management database to be accessible for a time matching windows algorithm and other processes herein.

The calendar management system 100 utilizes underlying secure multi-party computation (MPC) protocols to satisfy security properties. The MPC protocol needs to offer simulation-based security against an adversary that can take control of all but one of the participants (including the coordinator) and make them arbitrarily deviate from the protocol specification. Simulation-based security offers the guarantee that any attack launched by an attacker corrupting up to all but one of the parties cannot learn any additional information on inputs by the remaining parties beyond what can be inferred from the output of the computation. This type of security is referred to as security against an active (or byzantine or malicious) adversary that can statically corrupt simultaneously all but one of the parties (i.e. a dishonest majority protocol). An MPC protocol will be run by one or more nodes (for example, in the cloud). If a particular user requires stronger security, then in some embodiments the user can opt in through its client extension to be a node in the MPC protocol. Some of the MPC protocols that offer such security are concretely efficient. The calendar management system 100 may utilize an implementation of a secure MPC, including, for example, MPCs that offer security against an active adversary that can corrupt all but one of the MPC parties. Some examples of MPCs that offer security against an active adversary include MPCs using authenticated garbling protocols, SPDZ-type protocols, Diogenes MPC protocols (e.g., Chen et al., Diogenes. IEEE Symposium on Security and Privacy 2021: 590-607), LevioSA protocol (https://eprint.iacr.org/2020/393) or SCALE-MAMBA protocols (https://eprintiacr.org/2018/1045), the disclosures of which are hereby incorporated herein by reference in their entireties. Additional active secure MPC protocols can be found in https://eprint.iacr.org/2019/1250.pdf, the disclosure of which is incorporated herein by reference it is entirety.

Additional security features provided by various embodiments of the MPC component in the calendar management system 100, include, but are not limited to: security against adaptive corruptions (which models adversaries that corrupt parties during the execution of the protocol as opposed to those that decide which parties to corrupt at the beginning of the protocol); an identifiable abort, indicating a security feature that allows identification of a cheater (or group of cheaters) in case the execution aborts without completing: and/or a post-quantum security indicating a security feature that holds even if the attacker has access to quantum computers.

In many embodiments, the minimum information is revealed in the Meshcal system. Even if any one computer node is infected/hacked, the only information that can ever be revealed is the output of the computation, namely, a common meeting time. Secure multiparty computation allows the system to operate on encrypted data in a way that no single computer node in the system can decrypt information because the keys are “Secret-shared” among a group of computer nodes.

Some embodiments of the calendar management system 100 provide features of specifically identifying types of attendees and multi-step meetings.

The meeting or event attendees can be of the types Required or Optional. Some embodiments incorporate priorities among attendees and give consideration to the availability of attendees with higher priority according to the attendee types noted above. For example, a simple priority value can be incorporated via a 0 or 1 score, where attendees with a score of 1 are required to attend and attendees with a score of 0 are optional. The underlying MPC protocol can identify the set of timeslots where all the attendees associated with (Priority value 1) are available and then among these timeslots find one or more which maximize the availability of the optional attendees. In fact, given any procedure or algorithm (including, for example, artificial intelligence or machine learning algorithms) that captures how to determine a common time slot given the availability and/or busy vectors, and any other information can be incorporated into the MPC protocol.

Some embodiments of the calendar management system 100 facilitate a multi-step meetings feature. In manufacturing or project management, scheduling multi-step or multi-tool processes may be needed, and/or multiple meetings or events need to be scheduled under some constraints (e.g., precedence constraints). An MPC protocol can be enhanced to accommodate such scheduling where additionally the scheduler needs to submit as input the constraints and parameters of the meeting.

For simplicity of description, the example workflow embodiments described below specify only two MPC parties, a creator 130 of a meeting and an invitee 124 that is being invited to the meeting, in which a calendar management server performs steps as shown in FIG. 1 and FIG. 1B. The invitee represents one or more invitees that is being invited to the meeting, or in other words multiple parties—two or more parties—may be used or involved, for example 5, 10, 50, 100, 500 or more parties or invitees may be involved in embodiments herein.

Firstly, the scheduler 130 or the creator opens the calendar extension or web application and authenticates with the calendar service.

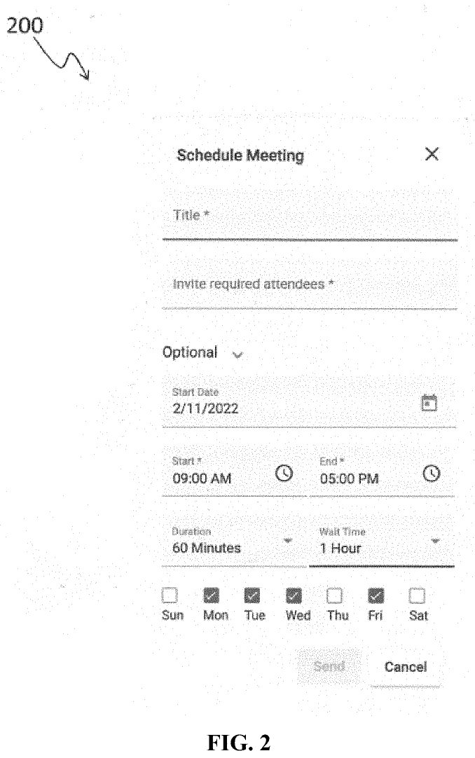

Secondly, the scheduler 130 creates a meeting invite or event 110 through the calendar extension by supplying parameters including, but not limited to, a meeting title; an email list of the invitees, a window of availability, a list of days of the week on which the meeting can be scheduled, a duration of the meeting, and a response wait time. FIG. 2 depicts an example of an embodiment of an application window 200 to create meeting parameters and respective values.

The window of availability is specified by a pair of start time and end time between which the meeting needs to be scheduled on any day. For example, the scheduler can specify a meeting window of 9:00 a.m. to 5:00 p.m. along with a time zone of the creator or for the meeting. The list of any of the days of the week on which the meeting can be scheduled, for example, indicating the selected days of the week from Monday through Sunday, as in for example “Monday through Wednesday and Friday”. The duration of the meeting can be set at a predetermined unit, for example, 15 minutes, 30 minutes, or 1 hour. The response wait time specifies a deadline by which an invitee needs to provide a response.

The calendar extension 124 securely submits the information to the calendar management server 150.

The calendar extension obtains the availability and/or busy vector(s) for the scheduler from the underlying calendar service. The calendar extension creates secret shares of the vector using the 2-out-of-2 XOR secret sharing scheme, denoting them by sh1, sh2. The calendar extension encrypts sh1 and sh2 using pk1 and pk2 respectively and submits the ciphertexts to the calendar management server.

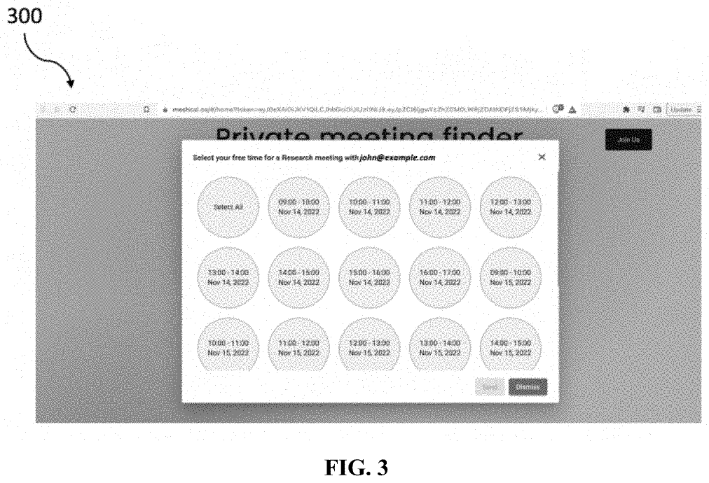

In another step, the calendar management server creates an entry in the calendar management database with the parameters of the event. The calendar management server sends a request to all the users in the email list: If the users have the calendar extension installed, then the request appears in the extension. If not, the request is sent as an email with a link to supply the information through the stand-alone client UI FIG. 3. The request includes the details of the meeting (i.e. the Scheduler's identity and title of the meeting) and the public-keys of the MPC parties (denote them by pk1, pk2).

In some embodiments where a user has the calendar extension installed or is operating through a web-based application, the user can either respond or dismiss a request. If the user agrees to respond, the calendar extension or web-based application obtains the availability and/or busy vector from the underlying calendar service. In some embodiments, the user may be able to review the time slots being offered as available prior to them being submitted to the system in order to allow the user to modify what will be presented as available time slots from his or her calendar. The calendar extension creates secret shares of the vector using the 2-out-of-2 XOR secret sharing scheme, denoting them by sh1, sh2. The calendar extension encrypts sh1 and sh2 using pk1 and pk2 respectively and submits the ciphertexts to the calendar management server.

In some embodiments where a user does not have the calendar extension or web-based application installed, a link is provided via email as shown in an exemplary notification email 300 of FIG. 3. This link will open a webpage where the user can provide its availability by manually selecting the time slots it is available. The user may also be offered the option of downloading the extension or installing the web-based program to synch their calendar with the system for future ease of use. Once the user provides its selection and agrees to respond, the webpage creates ciphertexts as in the calendar extension above and sends it to the calendar management server.

The calendar management server 150 receives ciphertexts from the users and updates or appends the row corresponding to the event in the calendar management database 102.

When all users have submitted their inputs or upon the response wait time period expiring, the calendar management server will send the inputs to nodes running the MPC protocol and signal the nodes to start the MPC protocol. In some embodiments, the MeshCal server submits the ciphertexts encrypted under pk1 to MPC party 1 and those under pk2 to MPC party 2 and sends a signal to start the MPC protocol. In some embodiments, two nodes in the AWS cloud are running the MPC protocol, but in other embodiments, as described above, there can be any number of nodes including client extensions from the user side to participate in the MPC protocol.

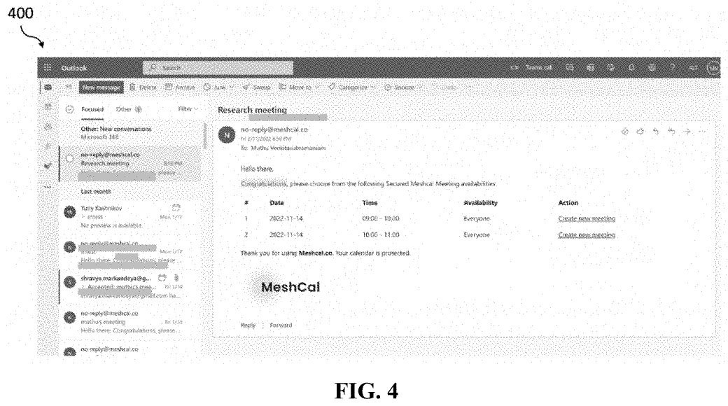

In an embodiment, the inputs are first “secret shared” and then encrypted. The number of shares depends on the number of nodes running the MPC. Each share of an input is then encrypted in such a way that only the corresponding node in the MPC can decrypt it. As a non-limiting example using two nodes running on the cloud, their public keys (for encryption) are known—the public keys may be denoted by pk1, pk2. If there were more nodes, then there would be public keys corresponding to all nodes participating in the MPC and secret shares equal to the number of nodes would be used. Upon receiving the ciphertexts, the MPC parties execute an MPC protocol. The output of the MPC protocol is a list of time slots where all the users are available which the coordinator relays back to the calendar management server. In more detail, the MPC party 1 and MPC party 2 have hard coded in their algorithm the secret key sk1 and sk2 respectively corresponding to the public key pk1 and pk2 respectively. They also have the IP address of the coordinator. When the MPC parties are provided as inputs the ciphertexts (mentioned above), the MPC parties run the protocol by exchanging messages through the coordinator (i.e. coordinator relays messages back and forth between the MK parties). The MPC parties and the coordinator run the MPC protocol to obtain a vector that contains time slots where all the users are available which the coordinator relays back to the calendar management server. Once the nodes complete the MPC protocol they relay the output of the computation to the calendar management server 150. The calendar management server 150 will then notify or message the scheduler 130 of the output, in some embodiments via automatic e-mail message 400 as depicted in FIG. 4.

The calendar management server notifies the scheduler of the available time slots via email, as shown for example in FIG. 4. The first available time slot may be provided, or the first three available time slots, or a larger number of available time slots may be set and provided in the system. In some cases, there may be a stronger privacy property called differential privacy included in which case the method to choose a slot from the available slots may include a differentially private algorithm

A calendar invite or notice may be sent by the Scheduler or may automatically be generated.

Certain embodiments can be extended by specifying the calendar extension as a party to the secure MPC, which will enforce data security even further.

Some embodiments allow schedulers to designate the participants as required invitee(s) or optional invitee(s), thus allowing the MeshCal system to ignore any optional invitees to proceed to provide a seamless scheduling flow without complication of parties. Also, in some embodiments an individual user can mark space on their calendar with different availability or priorities, that is, they could have timeslots that have events, but which are flagged as optional or available for certain priorities or certain users or schedulers. Such features of optional or required invitees and availability priorities or optionality may be set or defined through the MeshCal system or from the calendar system being used, for example the existing or standard Google or Outlook calendar features.

If the calendar management system does not initially identify one or more time slots from the invitee's calendars that are mutually available, then in an optional configuration one or more alternatives may be instituted or provided to the Scheduler. For example, a relaunch option may be presented whereby options for the Scheduler to remove some invitees and/or make some invitees optional may be offered. Alternatively or additionally, a new time period may be offered, for example a time frame (e.g., a week or month) further out in time, may be offered such that the Scheduler can simply relaunch the MeshCal process with a single button push for the new time frame. Another alternative may be for the calendar management system to provide the timeslot that is available to the highest number or portion of the invitees, or the highest number of prioritized invitees, and then offer the Scheduler the option, or automatically offer the unavailable invitees a manual option, to indicate whether they can shift their conflicting obligations to make themselves available for the identified time slot.

In some embodiments, an option may be offered to invitees such that they can set an automatic response to a MeshCal request (e.g., accepting the request to allow the MeshCal system to institute the available overlapping timeslot identification process) and/or they can receive a notice or alarm to alert them to a waiting MeshCal communication. This may be useful, for example, in making sure that timely responses are received to allow the MeshCal system to increase the likelihood of identifying an open time slot and locking in the calendar invite before calendars change. This may also allow for shorter response wait times as the Scheduler may have more confidence of receiving responses in a shortened time. Invitees would still receive the calendar invite, so even with an automatic response to the initial request, the invitee would still have a further notice and acceptance process through the calendar invite process.

In some embodiments, the calendar management system may be used on the internet, intranet, or via website. In some embodiments, the calendar management system may be used with one or more blockchains. In any of these embodiments a file storage system may be created that is decentralized and secure, consisting of a network of more than two nodes. This system will allow individuals to store their calendar availability or other data using secret sharing techniques that ensure any attacker who gains access to up to t out of the n nodes, where t is less than n, will not be able to learn anything about the stored information; the highest security level is when t=n−1.

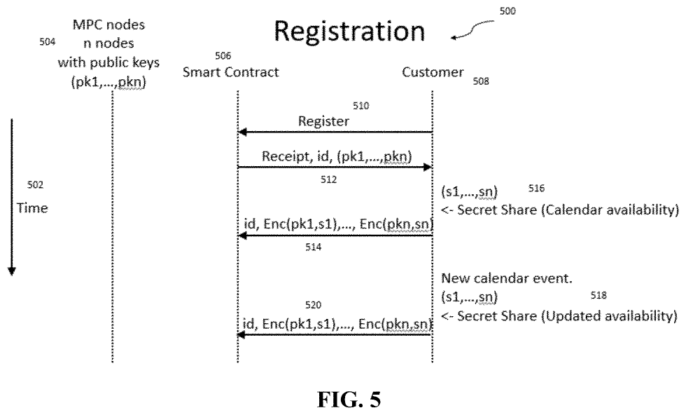

As shown in FIG. 5 for some embodiments of the decentralized calendar system used at least in part a smart contract and blockchain, a system of n nodes 504 called MPC nodes may be tasked with maintaining the calendars and assisting with finding a meeting time. Any user can onboard the system by first registering 500 with the calendar smart contract. Registration will involve providing some form of identification or registration information 510 (e.g., public-key, wallet) and a smart contract will issue a unique calendar id and the set of public-keys of the n MPC nodes 512. The user will push its existing calendar appointments 514 by first secret-sharing the calendar data using a t-out-of-n secret sharing scheme and then encrypting share i with public key of MPC node i (for i=1 , , , n). The encrypted shares along with the id is transmitted to the smart contract 506. Thereafter, when a user makes a new appointment 518, the update will be pushed to the smart contract by encrypting a secret-sharing of the update 520.

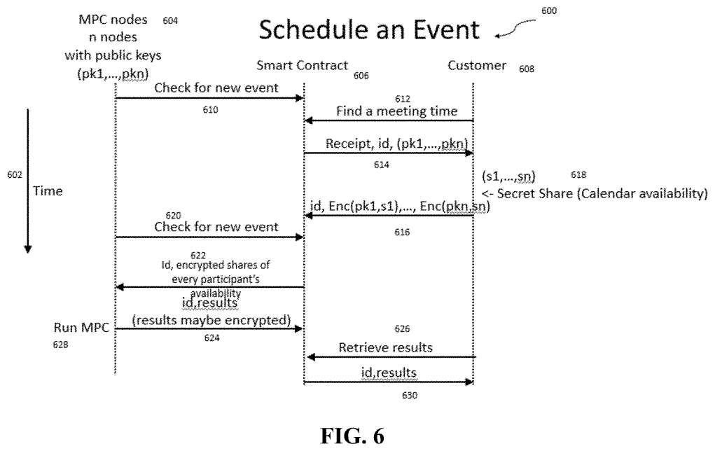

In some embodiments, the decentralized nodes may interact with a smart contract as depicted in FIG. 6 on a blockchain to facilitate finding a meeting time as follows: (1) When a user wants to schedule a meeting with one or more other users, regardless of whether those users have stored their availability on the blockchain system, they may define the meeting details and send tokens or other remuneration to the smart contract; (2) after the smart contract has approved the meeting details, the network of decentralized nodes will pick up the meeting parameters and notify all the users who have not stored their calendar information on the distributed nodes to provide their availability; and (3) once the availability of every person invited to the meeting is obtained (or the waiting time has elapsed) the nodes using an MPC protocol find a common meeting time as described above. The results are transmitted back to the smart contract. An additional layer of security may be provided in some instances where the encrypted results are transmitted to the smart contract in a way that only the scheduler can decrypt the results. A smart contract is generally a computer program or transaction protocol that is intended to automatically execute, control and/or document events and actions according to terms of an agreement or plan. Smart contracts are often described and used with or on a blockchain.

An embodiment of the calendar management system is shown in FIG. 6. When a user wants to schedule an event 600 or find a meeting time, the user or scheduler will issue a request 612 to a smart contract 606 and receive public-key information 614 of the n MPC nodes and an event id. The user will secret-share its availability 616 and encrypt with the corresponding public-keys and communicate that information to the smart contract 606. The user then waits for the result of the request to complete by monitoring the state of the smart contract. The MPC nodes may constantly, regularly, and/or frequently monitor the smart contract to check for new scheduling requests 610, 620. If a new request has been made, the smart contract retrieves the encrypted shares of the availability of all of the users invited to the meeting including the user that scheduled the meeting 626. Then each MPC node will decrypt the share encrypted with its public key 622. Using these shares, the MPC nodes will run the MPC protocol 628 to find a meeting time and return the results 624 to the smart contract (signed by their keys). The smart contract will store the results in plain or encrypted form (encrypted under the key of the user that scheduled the meeting). Finally, the user can obtain the result 630 by reading the state of the smart contract and decrypt if necessary).

In some embodiments, a hybrid system may be utilized wherein not all users have registered on or accessed the decentralized calendar system. In such a scenario the MPC nodes 604 can notify those users separately via an email and obtain encrypted secret shares of their availability using external communication. It will be understood that similar steps, systems and results may be realized using the calendar management system and methods in non-blockchain systems, for example internet or other communication systems and protocols.

In some examples, the user's data is not retained even in encrypted form after a time has been found, but rather is either never stored or is deleted immediately. However, in some systems, for example the blockchain smart contract described above, the user's data may be maintained by the network of distributed nodes. In the blockchain smart contract approach, an advantage may be that the step of needing to reach out to the user to get their data when an invite is made may be eliminated as they may have already stored their calendar data in a secure distributed file storage.

In some embodiments the MeshCal system 100 can be utilized to implement, for example, a voting system, a survey system, an auction system, a dating app, an insurance price comparison app, or a secured statistical service, among other applications. Many of these additional options may be included with or used in combination with the MeshCal calendaring protocols. For example, as the MeshCal system is finding available time slots amongst the Invitees, it could also include an opportunity to gather votes on a related topic or provide an auction element to set priorities for discussion. As an example, for a lunch meeting, the MeshCal system could find available time slots but also gather votes for lunch items. As another example, the MeshCal system could find available time slots but also allow participants to place bids on topics of discussion in an auction system whereby the top bids set the first priority of discussion or a ranked choice voting prioritizes the discussion topics.

For a voting system embodiment, the users simply provide their votes as input and the MPC computes a tally of the votes. The same flow as above can be used where the Scheduler initiates a vote supplying the list of user emails through the MeshCal extension and the users can respond either using MeshCal extension if installed, via a web-based system or through a Stand Alone UI, using, for example, a manual input system like shown for calendars in FIG. 3. The MeshCal system 100 can be used in a manner in which data exchange is secured and identities are protected for poll voting in an enterprise setting such as yay or nay voting by members of a board of the enterprise, features voting or polls in which multiple options are offered, and anonymity of respective votes is important.

For a survey system embodiment, voting described as above can be generalized to conduct surveys where the responses can be expressed via a numerical score and aggregation summarizes the numerical score via some formula such as a tally, an average, means, or medians, and other statistics, using, for example, a manual input system like shown for calendars in FIG. 3.

In an embodiment of an auction system, a scheduler acting as an auctioneer, or a seller, may initiate an auction of an item by providing a list of user emails and the users submit their bids, using, for example, a manual input system like shown for calendars in FIG. 3 and/or a simple typed entry stating the bid amount. The MPC protocol may be configured to identify the user with the highest bid, second highest bid or other types of auctions, and relay it back to the scheduler. This may be used in some cases with the calendar management system to auction time or access to an individual, whereby a limited number of attendees will be allowed into a meeting and/or only a few time slots are available for an important participant (for example a celebrity or powerful person), and bids may be taken to allow the highest bids to participate in the calendar process to set the common meeting time or times. In some examples, this may be done via smart contract such that a bidder submits a bid (e.g. amount of tokens or other remuneration), and the highest bidder automatically through the smart contract gets a calendar invite for the time slot he or she bid for.

In an embodiment of a dating app, the MeshCal system 100 is utilized to ensure privacy and safety for the users, by enabling matching of the common traits or important traits without exposing their actual private information without their consent. Users provide their traits and/or the traits they are looking for in a secured and private format on their client side, perhaps by filling out a form or drop-down menu options. Users create a match search, based on their criteria, then submit the search by sending that via MeshCal extension, any participants who are interested shall also submit their profile and traits to the MeshCal server, for example via MeshCal extension. The MeshCal server runs a matching algorithm and delivers the matches to their emails.

In an embodiment of an insurance price comparison application, the MeshCal system 100 provides assured privacy for users to apply for insurance pricing quotes without exposing their private data. In an embodiment of an insurance pricing quote or comparison application, the MeshCal system 100 is utilized to ensure privacy and safety for the users, by enabling receipt of price quotes without exposing their actual private information without their consent. Users provide their private information and/or the traits that are relevant to insurance, for example health history, driver record, insured property information, in a secured and private format on their client side. Users create a match search, based on their criteria and input, then submit the search by sending that via MeshCal extension. Any insurance provider can then participate to submit their quote and information to the MeshCal server, for example via Meshcal extension. The MeshCal server runs a matching algorithm and delivers the matches to their emails, for example in rank or random order, so that the user can choose a quote.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, blockchain, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

We claim:

1. A computer implemented method comprising:
accessing, by a secure calendar management device, two or more electronic calendars;
collecting, by the secure calendar management device, available times and dates from the two or more accessed electronic calendars via a preconfigured secure communication without accessing private data from the two or more electronic calendars using a secure multiparty computation mechanism;
identifying, by the secure calendar management device overlapping available times and dates on the two or more electronic calendars based on the collected available times and dates from the two or more electronic calendars; and
providing, by the secure calendar management device, a set of available times and dates for an event based on the identified overlapping available times and dates and an option to schedule the event during one of the available times and dates in the set of available times and dates; wherein the secure calendar management device comprises one or more processors.

2. The computer implemented method of claim 1, further comprising:
selecting, by the secure calendar management device, one of the available times and dates in the set of available times and dates; and
automatically creating, by the secure calendar management device, a calendar invite using the selected one of the available times and dates.

3. The computer implemented method of claim 2, wherein a first available time and date is selected from the set of available times and dates for the calendar invite.

4. The computer implemented method of claim 2, further comprising prioritizing, by the secure calendar management device, one or more days or one or more times; selecting, by the secure calendar management device, the one of the available times and dates in the set of available times and dates based on the prioritized one or more days or one or more times.

5. The computer implemented method of claim 1, wherein the two or more electronic calendars are associated with two or more invitees to a meeting.

6. The computer implemented method of claim 5, further comprising prioritizing, by the secure calendar management device, at least one of the invitees; and
selecting, by the secure calendar management device, one of the available times and dates in the set of available times and dates based on the prioritized at least one or the invitees.

7. The computer implemented method of claim 5, wherein the two or more electronic calendars are associated with invitees in two or more different organizations or in two or more different scheduling systems.

8. The computer implemented method of claim 1, wherein identifying is performed using a secure multiparty computation protocol.

9. The computer implemented method of claim 8, wherein the secure multiparty computation protocol is run on one or more nodes.

10. The computer implemented method of claim 9, wherein a user operates one of the nodes.

11. The computer implemented method of claim 8, wherein the secure multiparty computation protocol includes security against an active adversary.

12. The computer implemented method of claim 8, wherein the secure multiparty computation protocol is concretely efficient.

13. The computer implemented method of claim 8, wherein the secure multiparty computation comprises at least one of an active secure MPC protocol, authenticated garbling protocol, SPDZ-type protocol, LevioSA MPC protocol, SCALE-MAMBA protocol, or Diogenes MPC protocol.

14. The computer implemented method of claim 14, wherein only an electronic mail address for each invitee is used in the system for creating a calendar invite using one of the available times and dates.

15. The computer implemented method of claim 1, wherein the preconfigured secure communication includes communication using internet, web, cloud or blockchain protocols.

16. The computer implemented method of claim 1, wherein the two or more electronic calendars are associated with two or more invitees to a meeting, the method further comprising:
receiving, by the secure calendar management device, an optional manual input in the collecting step for one of the invitees to choose open times on its calendar for its available times and dates.

17. The computer implemented method of claim 1, wherein the invitee chooses open times from those that have been identified to be available times and dates from the other invitee's calendars.

18. The computer implemented method of claim 5, wherein one or more invitees may be identified as optional, and further comprising excluding that invitees available times from the identifying step if such optional invitee is not available during at least one time that overlaps with the available overlapping times of the other invitees.

19. A non-transitory computer readable medium having stored thereon instructions for calendar management and scheduling comprising machine executable code which When executed by at least one processor, causes the processor to:
access by a secure calendar management device, two or more electronic calendars;
collect, by the secure calendar management device, available times and dates from the two or more accessed electronic calendars via a preconfigured secure communication without accessing private data from the two or more electronic calendars using a secure multiparty computation mechanism;
identify, by the secure calendar management device overlapping available times and dates on the two or more electronic calendars based on the collected available times and dates from the two or more electronic calendars; and
provide, by the secure calendar management device, a set of available times and dates for an event based on the identified overlapping available times and dates and an option to schedule the event during one of the available times and dates in the set of available times and dates;
wherein the secure calendar management device comprises one or more processors.

20. A secure calendar management computing device, comprising a memory comprising program instructions stored thereon and one or more processors configure(to execute the stored program instructions to:
access by a secure calendar management device, two or more electronic calendars;
collect, by the secure calendar management device, available times and dates from the two or more accessed electronic calendars via a preconfigured secure communication without accessing private data from the two or more electronic calendars using a secure multiparty computation mechanism;
identify, by the secure calendar management device overlapping available times and dates on the two or more electronic calendars based on the collected available times and dates from the two or more electronic calendars; and
provide, by the secure calendar management device, a set of available times and dates for an event based on the identified overlapping available times and dates and an option to schedule the event during one of the available times and dates in the set of available times and dates;
wherein the secure calendar management device comprises one or more processors.
